(19) United States
(12) Patent Application Publication
(10) Pub. No.: US 2024/0326312 A1
(43) Pub. Date: Oct. 3, 2024

(54) DEVICE AND METHOD FOR PROCESSING PLASTICS MATERIAL

(71) Applicant: Coperion GmbH, Stuttgart (DE)

(72) Inventors: Leonid LIBER, Rutesheim (DE); Jochen SCHOFER, Stuttgart (DE)

(73) Assignee: Coperion GmbH, Stuttgart (DE)

(21) Appl. No.: 18/618,842

(22) Filed: Mar. 27, 2024

(30) Foreign Application Priority Data
Mar. 29, 2023 (EP) 23 164 897.3

(51) Int. Cl. B29C 48/69; B29C 48/375; B29C 48/76; B29C 71/02; B29K 105/26

(52) U.S. Cl. CPC B29C 48/69; B29C 48/375; B29C 48/767; B29C 71/02; B29K 2105/26

(57) ABSTRACT

A device for processing plastics material, comprising: a multi-shaft screw machine, in particular a twin-shaft screw machine, having at least two treatment element shafts mounted in a housing for plasticizing the supplied plastics material to form a plastics melt, wherein the multi-shaft screw machine has a plasticizing zone, a discharge zone, and a backup zone arranged between the plasticizing zone and the discharge zone, having at least one backup element which holds back the plastics melt; at least one melt channel which bridges across the backup zone, connecting the plasticizing zone and the discharge zone to one another, and at least one melt filter device for filtering the plastics melt, arranged and active in the melt channel.

### CROSS-REFERENCED TO RELATED APPLICATION

This application claims priority to European Application No. 23 164 897.3 filed on Mar. 29, 2023, the entire contents of which are hereby incorporated by reference.

### TECHNICAL FIELD

The disclosure relates to a device for processing plastics material, for example plastics recycling material and/or plastics waste. The disclosure also relates to a method for processing plastics material, such as plastics recycling material and/or plastics waste.

### BACKGROUND

Plastics recycling material, such as for example post-consumer waste, represents an important raw material source. In the case of plastics recycling material, however, the plastics are usually contaminated, for example with biomass, sand, paper, glass, aluminum, and the like. Plastics waste, especially packaging waste, is therefore often present exclusively as mixtures with a high degree of contamination. Recycling them is usually difficult, since the sorting and cleaning of the waste is in many cases not economically sensible or technically feasible. Chemical recycling is considered a promising process to allow recycling these material streams as raw material.

In chemical recycling, after the plastics recycling material has been introduced, shredded or compacted, into the process part of a twin-screw extruder, a great deal of mechanical energy is input into the plastics material over a very short time due to the continuous surface renewal and intensive dispersion and shearing via the twin shafts. Further substances, such as catalysts, may be metered in and mixed in as required. In some cases, water residues or chlorides from PVC are introduced into the extruder with the plastics waste. Both may be discharged via vacuum degassing at the process part of the extruder. The plastics melt is then fed to a pyrolysis reactor. In the reactor, the melt, which was previously heated in the twin-screw extruder, is further heated. At up to 500° C., the polymers undergo pyrolysis. At the same time, in the absence of oxygen, chain reactions are triggered which lead to cleavage of the polymers into a mixture of liquid and gaseous hydrocarbons. All inorganic constituents of the plastics recycling material remain in the bottom of the reactor and are discharged there. The organic hydrocarbons of the polymers are volatilized. They are converted to monomers, petrochemical fuels, or synthesis gases, and processed further in a distillator to output marketable products, such as oil, heavy oil, or waxes.

Since the plastics recycling material, in particular in the case of packaging waste, is present as a mixture with a high degree of contamination, it would be desirable to filter the contaminated plastics melt in order thus to enable better processing and to obtain higher-quality products.

### SUMMARY

The object of embodiments of the disclosure is to structurally and/or functionally improve a device mentioned at the outset for processing plastics material. In addition, the object of embodiments of the disclosure is to structurally or functionally improve a method for processing plastics material as mentioned at the outset. It is therefore an object of embodiments of the present disclosure to provide a processing device and a processing method which reduce or eliminate the problems indicated in connection with the prior art. For example, one object is to enable filtration of the plastics melt during the chemical recycling.

The object is achieved by a device having the features of claim 1. The object is further achieved by a method having the features of claim 9. Advantageous embodiments and/or further embodiments are the subject matter of the subclaims, the description and/or the accompanying FIGURES. Particularly, the independent claims of one category of claims may also be further defined and/or combined analogously to the dependent claims of another category of claims. The device and method features described below may also be combined with one another and/or further developed.

One aspect relates to a device for processing plastics material. The device may be a processing system.

The plastics material may be or comprise plastics recycling material. The plastics recycling material may be plastics waste—e.g., post-consumer plastics waste. The plastics recycling material may be post-consumer waste, for example packaging waste. In particular, the plastics recycling material may be plastics material which has to be chemically recycled. In embodiments, the plastics recycling material is used as plastics particles which in particular form a mixture with a high degree of contamination. Depending on the particle size and/or particle shape, the plastics particles may be in the form of plastics granules, plastics flakes, plastics fibers, or plastics powder, for example. The plastics particles may be recycling material. The plastics particles may also be cuttings-shaped and/or flake-shaped. The plastics recycling material may also have been shredded, ground, or compacted. In particular, the plastics recycling material or the plastics particles form bulk material. The plastics material may comprise-in particular, thermoplastic-polymers.

In embodiments, the device comprises a multi-shaft screw machine with at least two treatment element shafts mounted in a housing for plasticizing the supplied plastics material to form a plastics melt. The at least two treatment element shafts may be designed to plasticize and/or process the plastics melt. The housing may be a cylinder housing in which the at least two treatment element shafts are accommodated.

For feeding the plastics material into the multi-shaft screw machine, the multi-shaft screw machine may have a feed opening. In embodiments, the feed opening may be provided in an intake zone of the multi-shaft screw machine. In one variant, the feed opening may be a main feed opening, e.g. a main inlet, of the multi-shaft screw machine. The device may furthermore comprise a feed device and/or metering device for the feed of the plastics material. The plastics material may be supplied continuously and/or in metered manner, for example. Alternatively, the plastics material may be supplied discontinuously.

The screw machine may have a plasticizing zone, a discharge zone, and a backup zone arranged between the plasticizing zone and the discharge zone. The plasticizing zone may be directly/immediately upstream of the backup zone. The discharge zone may be immediately/directly downstream of the backup zone. The backup zone may, for example, have at least one backup element which holds back the plastics melt. The at least one backup element may be arranged in the housing. Multiple backup elements, for example two, three or four, backup elements, may also be provided. For example, each of the backup elements may be formed by, and/or arranged on, the treatment element shaft. For example, one backup element may be arranged on a first treatment element shaft, and a further backup element may be arranged on a second treatment element shaft.

The device may furthermore have at least one melt channel bridging the backup zone, which melt channel connects the plasticizing zone and the discharge zone to one another. The device may thus be designed to guide the plastics melt from the plasticizing zone through the melt channel into the discharge zone.

According to a variant, the device may have at least one melt filter device for filtering the plastics melt. The at least one melt filter device may be arranged and active in the melt channel. For example, a melt channel portion may lead into the melt filter device and/or be connected to an inlet of the melt filter device. Furthermore, a further melt channel portion may be connected to an outlet of the melt filter device. In the housing of the multi-shaft screw machine, an outlet into the melt channel leading to the melt filter device may be provided directly before the backup zone. Furthermore, an inlet of the melt channel coming from the melt filter device may be provided in the housing of the multi-shaft screw machine directly after the backup zone. A melt channel portion may therefore be connected by its one end to the outlet in the housing, and by its other end to the inlet of the melt filter device. A further melt channel portion may be connected by its one end to the exit of the melt filter device and by its other end to the inlet in the housing. Both the outlet and the inlet may be an opening in the housing through which the plastics melt may be guided out of the multi-shaft screw machine and/or may be re-introduced into the multi-shaft screw machine.

The at least one melt filter device may have at least one melt filter. The at least one melt filter may be operable continuously or discontinuously. The melt filter may have one or more filter units with a filter element. The filter element may be, for example, a filter screen and/or filter cylinder which is designed to filter the plastics melt. In one embodiment variant, the at least one melt filter device may have a pressure build-up unit for building up a melt pressure. The pressure build-up unit may be, for example, a melt pump and/or gear pump. The pressure build-up unit may be upstream of the melt filter, for example in such a way that the pressure build-up unit may press the plastics melt at a certain melt pressure through the melt filter.

In addition, at least one degassing opening for degassing may be provided in the housing of the multi-shaft screw machine. The at least one degassing opening may be arranged in the intake zone, the plasticizing zone, the backup zone or the discharge zone of the multi-shaft screw machine. For example, the at least one degassing opening may be connected to a degassing device, for example a vacuum degassing device. Alternatively, the at least one degassing opening may be designed for degassing and/or venting toward the atmosphere. Multiple degassing openings may also be provided, for example in all or different zones of the multi-shaft screw machine.

The multi-shaft screw machine may be designed as a multi-shaft screw machine rotationally driven in the same or opposite directions, and/or tightly-meshing. The at least two treatment element shafts may be rotatably mounted in the housing. The at least two treatment element shafts may be extruder screws. In embodiments, the multi-shaft screw machine may be designed as a twin-shaft screw machine. The multi-shaft screw machine may particularly be a twin-screw extruder. The plasticizing and/or processing may take place by means of the treatment element shafts of the multi-shaft screw machine.

A discharge opening may be provided on a last housing portion of the housing in the conveying direction. The plastics melt, in particular processed and/or degassed and/or filtered, may be discharged through the discharge opening. A reactor, an extrusion tool, an extruder head tool, a nozzle device or a screw machine may be connected to the discharge opening. The reactor may be a pyrolysis reactor. The pyrolysis reactor may be designed for the pyrolysis of the plastics melt. A distillator may be connected to the reactor. Alternatively, a filter device and/or a granulating device or another further processing system may be connected to the discharge opening.

A further aspect relates to a method for processing plastics material, in particular the plastics material described above and/or below. The plastics material may therefore be, for example, plastics recycling material. The method may be a processing method. The method may furthermore be carried out with the device described above and/or below.

In the method, the plastics material may first be fed into a multi-shaft screw machine. At least one additive may be added to the plastics material. The plastics material may be fed continuously by means of a feed device and/or metering device, for example. The plastics material may be fed continuously and/or metered. Alternatively, the plastics material may be supplied discontinuously. For example, the plastics material may be supplied via a feed opening of the multi-shaft screw machine. In one variant, the feed opening may be a main feed opening, e.g. a main inlet, of the multi-shaft screw machine.

The supplied plastics material may then be plasticized to form a plastics melt by means of the multi-shaft screw machine. The plasticizing may be a melting of the plastics material. The plasticizing may take place, and/or the multi-shaft screw machine may be controlled, in such a way that a certain melt temperature may be reached and/or maintained. The plasticizing may take place by means of at least two treatment element shafts of the multi-shaft screw machine, for example in the plasticizing zone of the multi-shaft screw machine. In an embodiment variant, the plasticizing may take place by means of precisely two treatment element shafts of the multi-shaft screw machine, such as a twin-shaft screw machine.

In the method, at least a portion of the plastics melt may be guided out of the multi-shaft screw machine. For example, the plastics melt may be removed from the multi-shaft screw machine completely and/or continuously. The removed plastics melt may then be filtered by means of a melt filter device. Subsequently, the filtered plastics melt may be returned to the multi-shaft screw machine.

In a further embodiment variant, the plastics melt may be homogenized and/or degassed. The degassing may take place, for example, via a degassing opening and/or with a degassing device. Furthermore, degassing may take place in the intake zone, the plasticizing zone, the backup zone and/or the discharge zone of the multi-shaft screw machine.

The processed and/or filtered and/or degassed plastics melt may then be discharged from the multi-shaft screw machine. In a variant, the filtered plastics melt discharged from the multi-shaft screw machine may then be supplied to a reactor, for example a pyrolysis reactor. The pyrolysis of the plastics melt may then take place in the reactor. A distillator may be connected to the reactor. After the pyrolysis, a distillation may take place. Alternatively, the filtered plastics melt discharged from the multi-shaft screw machine may be filtered by means of a filter device and/or granulated by means of a granulating device. In one variant, the filtered plastics melt discharged from the multi-shaft screw machine may be supplied to an extrusion die, an extruder head tool, a nozzle device, a screw machine, a filter device, a granulating device or another further processing system.

With embodiments, the contaminated plastics melt may be filtered in an energy-efficient manner during chemical recycling. The processing of the plastics material may thereby be improved.

### BRIEF DESCRIPTION OF THE DRAWINGS

Exemplary embodiments are described in more detail below with reference to figures, in which the following are shown schematically and by way of example:

FIG. 1 shows a partial cutaway view of a device for processing plastics material.

### DETAILED DESCRIPTION

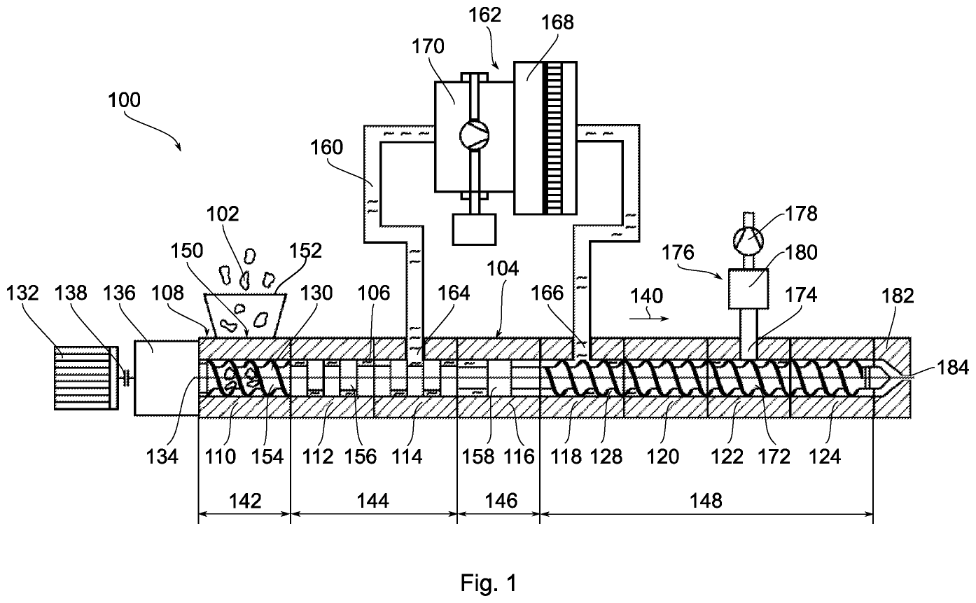

FIG. 1 shows a processing device 100 for processing plastics recycling material 102. The processing device 100 comprises a multi-shaft screw machine 104 and serves to plasticize the plastics recycling material 102 to form a plastics melt 106 for filtering the melted plastics melt 106 and for the processing of the plastics melt 106.

The multi-shaft screw machine 104 is designed as a co-rotating twin-shaft screw machine, here as a twin-screw extruder. The multi-shaft screw machine 104 comprises a housing 108 made of multiple successively arranged housing portions 110 to 124, which are connected to one another to form the housing 108. Two housing bores 128 which are parallel to one another and penetrate one another are formed in the housing 108, and have the shape of a lying figure eight in cross-section. The multi-shaft screw machine 104 further comprises two treatment element shafts 130 arranged concentrically in the housing bores 128, which may be rotationally driven by a drive motor 132 about associated axes of rotation 134. A branching transmission 136 and a coupling 138 are arranged between the treatment element shafts 130 and the drive motor 132. By means of the drive motor 132, the two treatment element shafts 130 are rotationally driven in the same direction, i.e. in the same directions of rotation, about the axes of rotation 134. The treatment element shafts 130 are designed to plasticize the supplied plastics recycling material 102 to form the plastics melt 106, and to process the plastics melt 106.

As shown in FIG. 1, in a conveying direction 140, the multi-shaft screw machine 104 has an intake zone 142, a plasticizing zone 144, a backup zone 146, and a discharge zone 148.

In the intake zone 142, the housing portion 110 has a feed opening 150 with a main intake funnel 152 for feeding the plastics recycling material 102 into the multi-shaft screw machine 104. In the intake zone 142, the treatment element shafts 130 comprise screw elements 154 for conveying the plastics recycling material 102 in the conveying direction 140.

A melting of the plastics recycling material 102 takes place in the plasticizing zone 144. For melting, the treatment element shafts 130 have kneading elements 156 designed as kneading discs in the plasticizing zone 144. In the plasticizing zone 144, the plastics recycling material 102 is melted to form the plastics melt 106. In addition, the plastics melt 106 may be homogenized in the plasticizing zone 144.

The backup zone 146 is arranged between the plasticizing zone 144 and the discharge zone 148. An accumulation of the plastics melt 106 takes place in the backup zone 148. For this purpose, the treatment element shafts 130 in the backup zone 144 each have a backup element 158, for example a baffle plate. As a result of the accumulation, the plastics melt 106 is pressed back substantially counter to the conveying direction 140. The processing device 100 furthermore has a melt channel 160 which bridges the backup zone 146 and connects the plasticizing zone 144 and the discharge zone 148 to one another. A melt filter device 162 for filtering the plastics melt 106 is arranged and is active in the melt channel 160. The plastics melt 106 pressed back by the backup element 158 is pressed through an outlet 164 present in the housing 108 directly upstream of the backup zone 146 into the melt channel 160 leading to the melt filter device 162.

The melt filter device 162 has a melt filter 168 that may be operated continuously or discontinuously. The melt filter 168 may comprise one or more filter elements which are designed to filter the plastics melt 106. Furthermore, the melt filter device 162 has a pressure build-up unit 170 designed as a melt pump for building up a melt pressure. By means of the pressure build-up unit 170, the plastics melt 106 may be pressed through the melt filter 168 at a certain pressure.

After the plastics melt 106 has been filtered through the melt filter device 162, it is returned to the multi-shaft screw machine 104 by an inlet 166 of the melt channel 160 coming from the melt filter device 162, directly after the backup zone 146 in the housing 108, wherein the filtered plastics melt 106 then passes into the discharge zone 148.

In the discharge zone 148, the treatment element shafts 130 have screw elements 172, for example conveying screw elements 172, for discharging the filtered plastics melt 106. Furthermore, a degassing opening 174 for degassing the plastics melt 106 is formed in the housing portion 122. The degassing opening 174 is connected to a vacuum degassing device 176, so that the plastics melt 106 is degassed via the degassing opening 174 by means of the vacuum degassing device 176. The vacuum degassing device 176 comprises a vacuum pump 178 which is connected to the degassing opening 174 via a separator 180. Alternatively, the degassing opening 174 may be designed for degassing and/or venting toward the atmosphere. A nozzle plate 182 which seals the housing 108 and forms a discharge opening 184 is arranged on the last housing portion 124. The filtered plastics melt 106 may be discharged through the discharge opening 184. A reactor, in particular a pyrolysis reactor, may be connected to the discharge opening 184 (not shown in detail in FIG. 1). The reactor may be designed for pyrolysis of the discharged, filtered plastics melt 106. A distillator may additionally be connected to the reactor.

The processing device 100 and/or its multi-shaft screw machine 104 is in particular designed to plasticize and filter the plastics melt 106. The contaminated plastics melt may thus be filtered during chemical recycling by means of a twin-screw extruder.

The processing of the plastics recycling material 102 and/or the processing method using the processing device 100 are described below.

The comminuted plastics recycling material 102 is supplied, for example by means of a feed device and/or via the main intake funnel 152, into the multi-shaft screw machine 104, and then passes into the intake zone 142. In the intake zone 142, the plastics recycling material 102 is conveyed in the conveying direction 140 to the plasticizing zone 144. The supplied plastics recycling material 102 is then melted in the plasticizing zone 144 by means of the treatment element shafts 130 and/or their kneading elements 156 to form a plastics melt 106.

Immediately before the backup zone 146, at least a portion of the plastics melt 106 is led out of the multi-shaft screw machine 104 and then filtered by means of the melt filter device 162. The filtered plastics melt 106 is then returned to the multi-shaft screw machine 104, where it passes into the discharge zone 148.

Gases escaping from the plastics melt 106 are discharged in the discharge zone 148 by means of the vacuum degassing device 176. Subsequently, the filtered plastics melt 106 is discharged from the multi-shaft screw machine 104.

The discharged plastics melt 106 may then be supplied to a reactor, for example a pyrolysis reactor. The pyrolysis of the plastics melt 106 may then take place in the reactor. A distillator may be connected to the reactor, so that a distillation may take place after the pyrolysis.

Alternatively, the filtered plastics melt 106 discharged from the multi-shaft screw machine 104 may be filtered by means of a filter device and/or granulated by means of a granulating device. In another variant, the filtered plastics melt 106 discharged from the multi-shaft screw machine 104 may be supplied to an extrusion tool, an extruder head tool, a nozzle device, a screw machine or another further processing system.

The term “may” refers in particular to optional features. Accordingly, there are also developments and/or exemplary embodiments which additionally or alternatively have the respective feature or the respective features.

From the feature combinations disclosed in herein, isolated features may also be singled out as required and, by resolving an optionally existing structural and/or functional relationship between the features in combination with other features, be used to delimit the subject matter of the claim. The order and/or number of method steps may be varied.

### REFERENCE SIGNS

100 Processing device
102 Plastics recycling material
104 Multi-shaft screw machine
106 Plastics melt
108 Housing
110-124 Housing portions
128 Housing bores
130 Treatment element shafts
132 Drive motor
134 Axes of rotation
136 Branching transmission
138 Coupling
140 Conveying direction
142 Intake zone
144 Plasticizing zone
146 Backup zone
148 Discharge zone
150 Feed opening
152 Main intake funnel
154 Conveyor screw elements
156 Kneading elements
158 Backup element
160 Melt channel
162 Melt filter device
164 Outlet
166 Inlet
168 Melt filter
170 Pressure build-up unit
172 Screw elements
174 Degassing opening
176 Vacuum degassing device
178 Vacuum pump
180 Separator
182 Nozzle plate
184 Discharge opening

What is claimed is:

1. A device for processing plastics material, comprising:
a multi-shaft screw machine, in particular a twin-shaft screw machine, having at least two treatment element shafts mounted in a housing for plasticizing the plastics material to form a plastics melt, wherein the multi-shaft screw machine has a plasticizing zone, a discharge zone, and a backup zone arranged between the plasticizing zone and the discharge zone, having at least one backup element which holds back the plastics melt;
at least one melt channel which bridges across the backup zone, connecting the plasticizing zone and the discharge zone to one another, and
at least one melt filter device for filtering the plastics melt, arranged and active in the melt channel.

2. The device according to claim 1, wherein an outlet into the melt channel leading to the melt filter device is provided in the housing immediately before the backup zone, and in that an inlet of the melt channel coming from the melt filter device is provided in the housing immediately after the backup zone.

3. The device according to claim 1, wherein the at least one melt filter device has a melt filter that can be operated continuously or discontinuously.

4. The device according to claim 1, wherein the at least one melt filter device has a pressure build-up unit, in particular a melt pump, for building up a melt pressure.

5. The device according to claim 1, wherein at least one degassing opening for degassing is provided in the housing, wherein the at least one degassing opening is arranged in an intake zone, the plasticizing zone, the backup zone, or the discharge zone of the multi-shaft screw machine.

6. The device according to claim 5, wherein the at least one degassing opening is connected to a degassing device, in particular a vacuum degassing device, or in that the at least one degassing opening is designed for degassing and/or venting to atmosphere.

7. The device according to claim 1, wherein the multi-shaft screw machine is a twin-screw extruder.

8. The device according to claim 1, wherein a discharge opening is provided on a last housing portion of the housing in the conveying direction, through which the plastics melt can be discharged, wherein a reactor, an extrusion tool, an extruder head tool, a nozzle device, or a screw machine is connected to the discharge opening, or wherein a filter device and/or a granulating device is connected to the discharge opening.

9. A method for processing plastics material, comprising the following steps:
feeding the plastics material into a multi-shaft screw machine, in particular a twin-shaft screw machine;
plasticizing the plastics material by means of the multi-shaft screw machine to form a plastics melt;
removing at least a portion of the plastics melt from the multi-shaft screw machine;
filtering the discharged plastics melt by means of a melt filter device; and
returning the filtered plastics melt into the multi-shaft screw machine.

10. The method according to claim 9, wherein the plastics melt is homogenized and/or degassed.

11. The method according to claim 9, wherein the plastics melt is discharged from the multi-shaft screw machine and then a pyrolysis of the plastics melt takes place by means of a reactor, such as a pyrolysis reactor.

12. The method according to claim 9, wherein the plastics melt is discharged from the multi-shaft screw machine and is then supplied to a reactor, an extrusion tool, an extruder head tool, a nozzle device, a screw machine, a filter device, a granulating device, or a further processing system.
